(19) United States
(12) Patent Application Publication
(10) Pub. No.: US 2013/0325730 A1
(43) Pub. Date: Dec. 5, 2013

(54) PROPERTY CENTRIC DIGITAL COMMUNITY

(71) Applicants: Mary RUDDY, Longmont, CO (US); Max RUDDY, Highlands Ranch, CO (US); Michael J. RUDDY, Longmont, CO (US)

(72) Inventors: Mary RUDDY, Longmont, CO (US); Max RUDDY, Highlands Ranch, CO (US); Michael J. RUDDY, Longmont, CO (US)

(21) Appl. No.: 13/909,069

(22) Filed: Jun. 3, 2013

Related U.S. Application Data
(60) Provisional application No. 61/654,685, filed on Jun. 1, 2012.

(51) Int. Cl. G06Q 50/16

(52) U.S. Cl. CPC G06Q 50/16; H04L 65/403
USPC 705/313

(57) ABSTRACT

Provided herein are systems and methods for providing a property centric digital community for home owners, renters, and buyers.

### CROSS REFERENCE TO RELATED APPLICATIONS

This application claims the benefit of priority to U.S. Provisional Patent Application No. 61/654,685; titled “PROPERTY CENTRIC DIGITAL COMMUNITY”; filed Jun. 1, 2012 under Attorney Docket No. REPA-2011003; and naming inventors Mary RUDDY, Max RUDDY, Sam POWERS, and Michael J RUDDY. The above-cited application is incorporated herein by reference in its entirety, for all purposes.

### FIELD

The present disclosure relates to owner populated property listing database creation, management and publication, and more particularly, to systems and methods for providing owners with a property centric digital community using an independent national on-line listing service and database.

### BACKGROUND

Buyers and sellers agree that a structural change is needed in the way we market America's principal asset, namely their homes and property. The data available today, as viewed by the consumer, is edited, aggregated, conflicted, and inaccurate.

Sellers today are looking for better answers. It's not just a poor market condition that requires the additional time. Or, that there are additional costs necessary to accomplish a sale. The real estate world, as we know it today, is a mess of competing venues, promoting various strategies and pricing structures; consisting of Realtors®, and sellers for the most part, dependent on each other to some degree. Sellers are now questioning the traditional Realtor® and associated costs, pursuing a different path . . . . Perhaps the sellers are tired of paying for the inefficiencies. Or maybe there isn't enough equity left in the property to allow for such exorbitant costs. The owner wants to be in control, save money, and quickly receive accurate market information.

Nearly 1 in 3 Homeowners are Selling Without a Traditional Agent

There has also been a shift on both sides, acknowledging the need to share each other's information. The sellers need the MLS program to achieve the exposure that the strict For-Sale-By-Owner (FSBO) site does not offer. And the Realtors® need the FSBO information for data analysis and the possible buyer agency sale. Although, it is generally believed that the more information available for everyone the better, there are several challenges that currently exist when using information produced by a middleman unfamiliar with the property in question.

It will be helpful to look at the process from the beginning (listing type I), with an understanding the Seller's point of view. The seller can agree to a listing contract (seller agency) with an agent/firm (the document will advise you to consult an attorney, due to its legal nature), and commit to a fee structure (usually 5.6-7%) to accomplish the transaction. Then, the seller, subject to state laws, will be asked to sign disclaimers and disclosures; relating to everything from relationships with conflicted parties (title insurance companies), transaction broker agreements (due to other agents within the firm providing a buyer), taxes, square footage calculations, mold disclosure and a seller's property disclosure form dealing with structural conditions, landscape lighting and ADA compliance. All are designed (presumably from prior negative issues) to move potential liability back to the seller.

Now that all the documents are signed the property can be uploaded to the local Multiple Listing Service (MLS) for sale. This may be considered the traditional method for selling a home with no upfront costs to the seller. But, depending on the agreed sale commission percentages, could end up costing somewhere between 5.6% and 7%.

Another choice that the seller has available may be a for-sale-by-owner listing (FSBO) on a website (listing type II). The seller may provide and input the pertinent data relating to their respective listing. Typically, these sites seldom allow for a co-op commission structure, but there are exceptions. The upfront cost to the owner may be a flat entrance fee and the information may not be posted on any MLS program. This strategy may attract the seller who cannot afford the Realtor® or desires to save as much money as possible.

Recently, the hybrid website (listing type III) evolved to better serve the interests of the cost-conscious seller by offering: Free entrance to their individual database as their first option (with seller providing the input) and then an upgrade into the Realtor.com system for a fee. Sites are becoming more complex with various menu offerings such as: Websites for the home, local MLS listings, and discounted seller-side commission structures. This type of website is devoted to reducing the seller costs while still offering the MLS exposure.

The buyer on the other side of the transaction has another set of decisions to make. For illustration purposes, let's assume an out of state purchase. The buyer requires a zip code or city to begin and will, by market share assumption, go to Realtor.com®, MLS.com®, or any of the other top thirty sites that Mash-up or link individual MLS® sites, plus all other individual sites and databases. The information will most likely be duplicated on some sites, outdated in status on others, and in conflict with existing competitive listings. Here is an excerpt from a Trulia® White Paper espousing the need for MLS syndication and affirming the problem:

Listing Syndication—A Critical Time for the Real Estate Industry

The real estate industry is facing a major challenge: the distribution of inaccurate listing data across the Internet. Data inaccuracies are a problem affecting the entire industry, from large destination sites like Trulia to individual agents, and everyone in between. It is incumbent upon all of us in the industry to provide the most accurate and comprehensive data possible to consumers searching for homes.

In recent months, the listing syndication landscape has changed dramatically. ListHub, the nation's most widely adopted network for listing syndication, working with more than 300 MLSs and over 85% of brokerages nationwide, was acquired by Move in September 2010. One week later, Point2, the second largest syndication platform working with over 150 MLSs was acquired by Yardi Systems, a real estate investment and property management software company. Most recently, Postlets, which syndicates more than 350,000 for-sale and for-rent listings across the country, was acquired by Zillow.

Many MLSs and their members are now asking “Who is distributing my data”, “Where is my data going?”, “Who is using it, and for what purpose?”, and most importantly, “How can we ensure the accuracy of data that's being distributed?!” With literally millions of listings being distributed to thousands of sites every single day, answering these questions is not an easy task. It requires access to thousands of data feeds containing millions of listings that can be evaluated against the very best source available, the Multiple Listing Service database.

Trulia® White Paper May 2011

Thus, the buyer is trying to find a home amidst thirty different sites of types I, II, or III. Which, by definition of site type, may be duplicated to the MLS; depending on how many local MLS numbers are referenced within any particular site. Clearly, the buyer's search becomes increasingly frustrating. Once everyone finally makes it to the MLS on their own respective pathway, the waste-of-time clock starts. Obviously, the more assets the Realtor® has listed, the better chance the Realtor has of selling a property to a buyer. The Realtors' links become the site strategy, through the broker's listing assets, with cross marketing strategies and agency advertising; purposely taking the buyer down the rabbit hole to other sites; including realtor web pages. This makes the buyers return to his/her starting point so cumbersome that it most likely will require shutting down their browser completely before returning to Realtor.com® or MLS.com®. Why are there thirty sites . . . all utilizing the same questionable information?

### BRIEF DESCRIPTION OF THE DRAWINGS

FIG. 1 illustrates a suitable operating environment for a property centric digital community in accordance with at least one embodiment.

FIGS. 2A-2E illustrates several examples of different on-line Digital Communities in accordance with various embodiments.

FIG. 3 illustrates a suitable operating environment for an owner based property centric digital community system in accordance with at least one embodiment.

FIG. 4 illustrates several components of a property server in accordance with one embodiment.

FIG. 5 illustrates a series of communications between various devices generating buyer initiated home dialogue for a Home participating in a property centric digital community in accordance with one embodiment.

FIG. 6 illustrates a series of communications between various devices generating a key approval and authorization for a buyer to a home participating in a property centric digital community in accordance with one embodiment.

FIGS. 7 illustrates a series of communications between various devices generating owner initiated home dialogue for a Home participating in a property centric digital community in accordance with one embodiment.

FIG. 8 illustrates a series of communications between various devices to register and verify a user to join a property centric digital community in accordance with one embodiment.

FIG. 9 illustrates several components of a property centric digital community in accordance with one embodiment.

FIGS. 10-23 illustrate screenshot representations of a property centric digital community in accordance with one embodiment.

### DESCRIPTION

In an effort to overcome the previously identified shortcomings of existing products that are currently available, one embodiment of the invention provides the following answer: Create a new independent national registry designed to remove the real estate broker's information dominance and inefficiencies: specifically, replace the notion that all consumer sources of information be a Mash-up of unreliable Broker/MLS information ... which is found, duplicated, and lost in on-line viewings. Ideally, the property owner, free of conflict and without cost, is the best source and may control the new marketing direction. In accordance with various embodiments of the present invention, an independent property centric digital community may provide consumers with the services and tools needed to overcome the previously described shortcomings in the existing real estate marketplace. Registry Path, LLC (http://www.quiltip.com) provides access to some of these social networking services and tools via an independent national database based on owner populated information that includes at least one embodiment of such an independent property centric digital community.

The seller's home will come first and be the easiest for the buyer to find. It may not simply be just a part of an agent/broker's co-op effort to sell whatever they can. We are not advocating the need to eliminate the real estate industry, far from it. We have intentionally included the industry. It is important and sometimes necessary to have a realtor involved at some level of the transaction some of the time. The transaction may also dictate the need for an attorney to be involved as most contracts propose; especially with complex transactions such as short-sales, and the like.

Outside of the present invention, a free owner source independent listing database is not currently in existence. The original MLS database was designed to function from within the Realtor® environment (to serve those interests), however today, the MLS database is now marketing their services outside of their original intention in a second-rate fashion against today's available simple Cloud/Colocation technology. The word seller was derived from the second place nature of: you had to be a seller to be included in the Realtor's® MLS realm. Now that the MLS information system is available for all to use . . . to post a listing for a fee, shouldn't we examine our options? Start over. A real estate listing, either as entered by agent or for an upfront fee, should not be the requirement to be listed on any national database.

But first let's get rid of the word seller and use the appropriate title of “Owner”. Additionally, let's envision an alternative program that puts the Owner in charge. Regardless, it's the owner who will recoup his/her investment, lose money, incur a loan deficiency, suffer a tax consequence, live with a foreclosure, or bankruptcy. Instead, there should be one comprehensive dedicated national database that treats each home uniquely, friction free without conflict? Populated first by the owner's input at no cost, without a strategy to morph into a fee. The search engine will be vertically integrated in the application without outside influence and needless advertising?

At the same time, the “Owner” may access and control/command a new/pristine, no cost structure for providing listing information about the property; and may participate in a restructuring of the commission in consideration for finding that all-important buyer. As the system makes the market more efficient, the system also helps to lower the overall cost of every transaction. In one embodiment, efforts are made on the site to reduce traditional bias against an “Owner” listing by using a property centric listing instead. In fact, an “Owner” listing on a property centric listing service would likely have a better quality and a larger quantity of accurate information. As such, an “Owner” listing in a property centric system may no longer be perceived negatively by the Broker, and at the very least should not be frowned upon by any of the community. Particularly, as the “Owner” is concerned with the protection and integrity of the individual listing as that listing tends to also promote the owners' interests in the property. In one embodiment, the owner is allowed input in other variables associated with the listing. For example, the owner may selectively indicate availability, acceptable offers based on a specified range or relative to a listing price of designated target properties or to a percentage of the current listing price. The owner may choose to reveal these variables and their respective settings, or merely use the variables to consider offers and optional add-ons to the home listing. This flexibility allows the owner to keep the listing fresh and in tune with changes that have been designated important. With respect to sales listings, other commission considerations can be negotiated by the owner upfront in case of an uncertain outcome.

In one embodiment, a new model for home sales is developed before the sale is even contemplated by possible participants. The home should be able to recite its own story, not just be a commodity to be sold according to a dollar per square foot ($/SF) ratio. The homes' story is not fill-in-the-form listing agreements that are wrought with legal warnings and addendum disclaimers. But the story may, in various embodiments, be taken in context or adjusted additionally, by the value of surrounding neighborhoods, noise pollution, taxes, quality school, and other factors that interest buyers.

Housing will continue to struggle in the years to come as supply and demand stabilize in the evolving economy. Prices will continue the descent to affordability and newly initiated public policy and tax reform will only offer remedial help at a cost to the taxpayer.

The consumer on either side of the transaction will make the ultimate decision as to which listing site-type they choose. The responses to the questions posed above will dictate the opportunity for the development of a new website. A website which includes a comprehensive/independent national database that is homeowner-priority driven. In one embodiment, the website will be free of cost. The new website cannot rely on other out-sourced information, only that which the Owner provides.

Reference is now made in detail to the description of the embodiments as illustrated in the drawings. Particular embodiments described in this application provide specific case implementations of a property centric digital community. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

Various aspects of the illustrative embodiments will be described using terms commonly employed by those skilled in the art to convey the substance of their work to others skilled in the art. However, the embodiments described herein may be practiced with only some of the described aspects. For purposes of explanation, specific numbers, materials, and configurations may be set forth to provide a thorough understanding of the illustrative embodiments. However, the embodiments described herein may be practiced without the specific details. In other instances, well-known features are omitted or simplified in order not to obscure the illustrative embodiments.

Further, various operations and/or communications may be described as multiple discrete operations and/or communications, in turn, in a manner that may be helpful in understanding the embodiments described herein; however, the order of description may not be construed as to imply that these operations and/or communications are necessarily order dependent. In particular, these operations and/or communications need not be performed in the order of presentation.

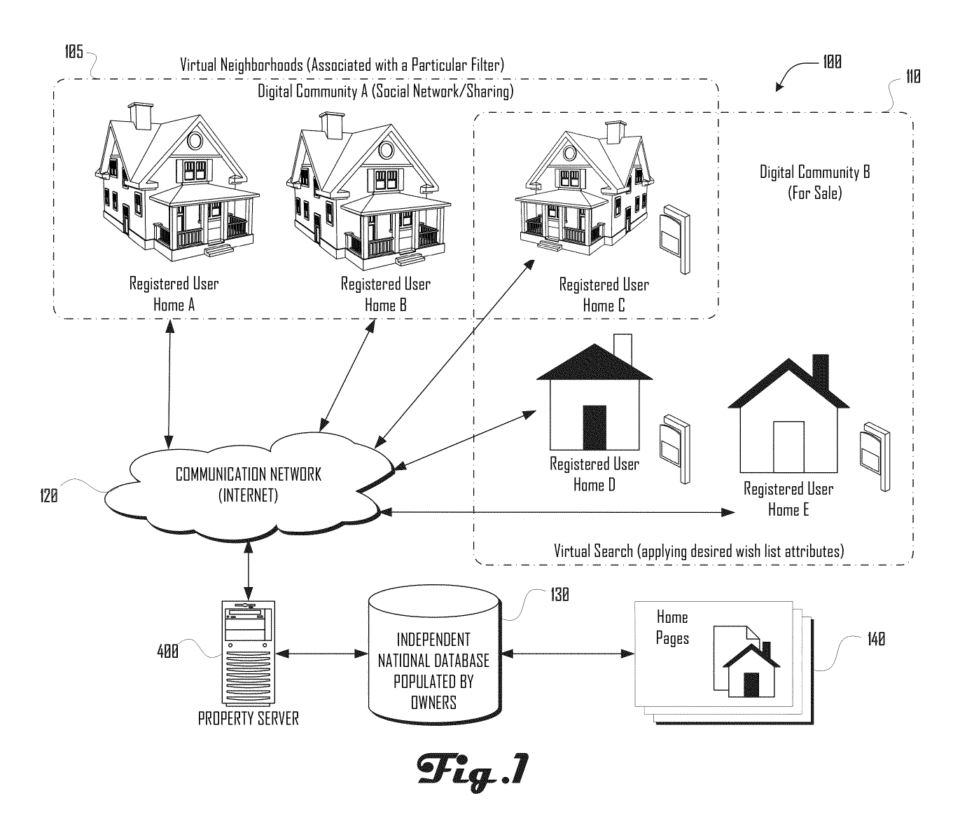

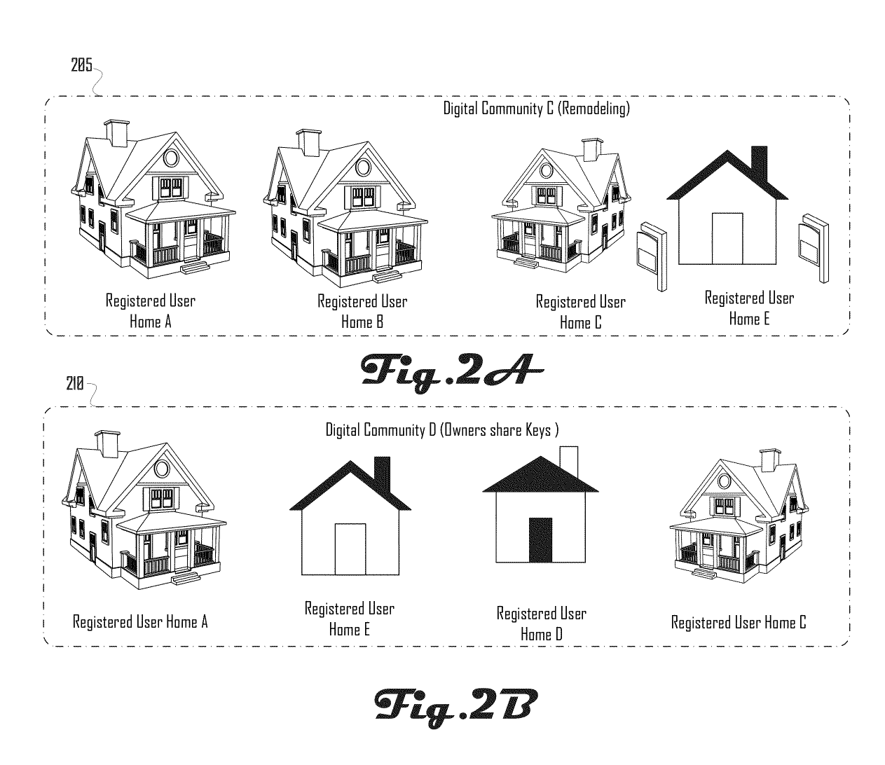

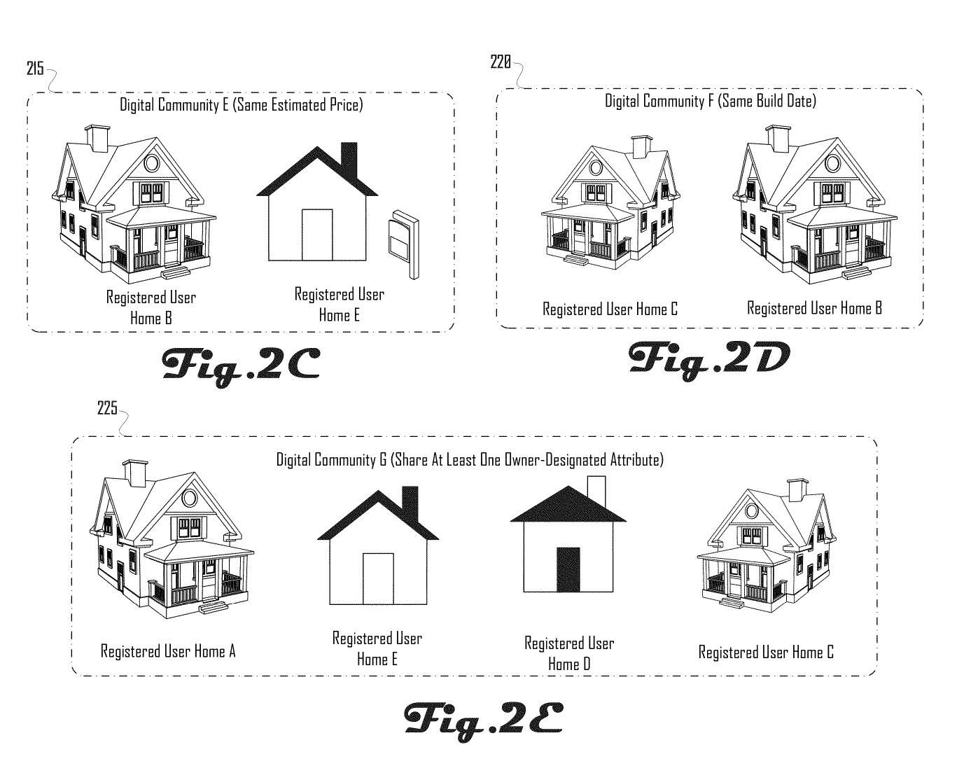

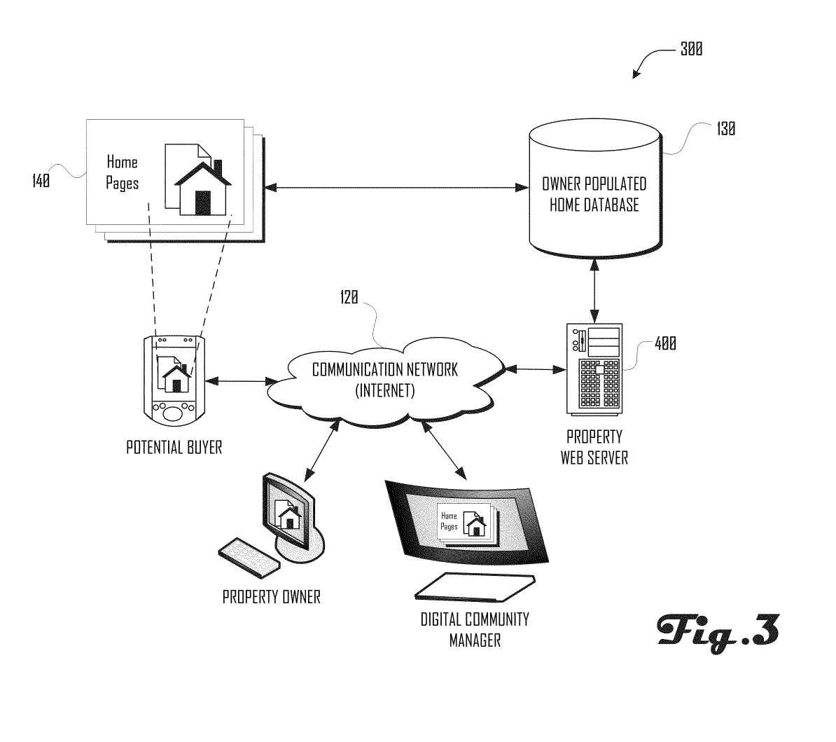

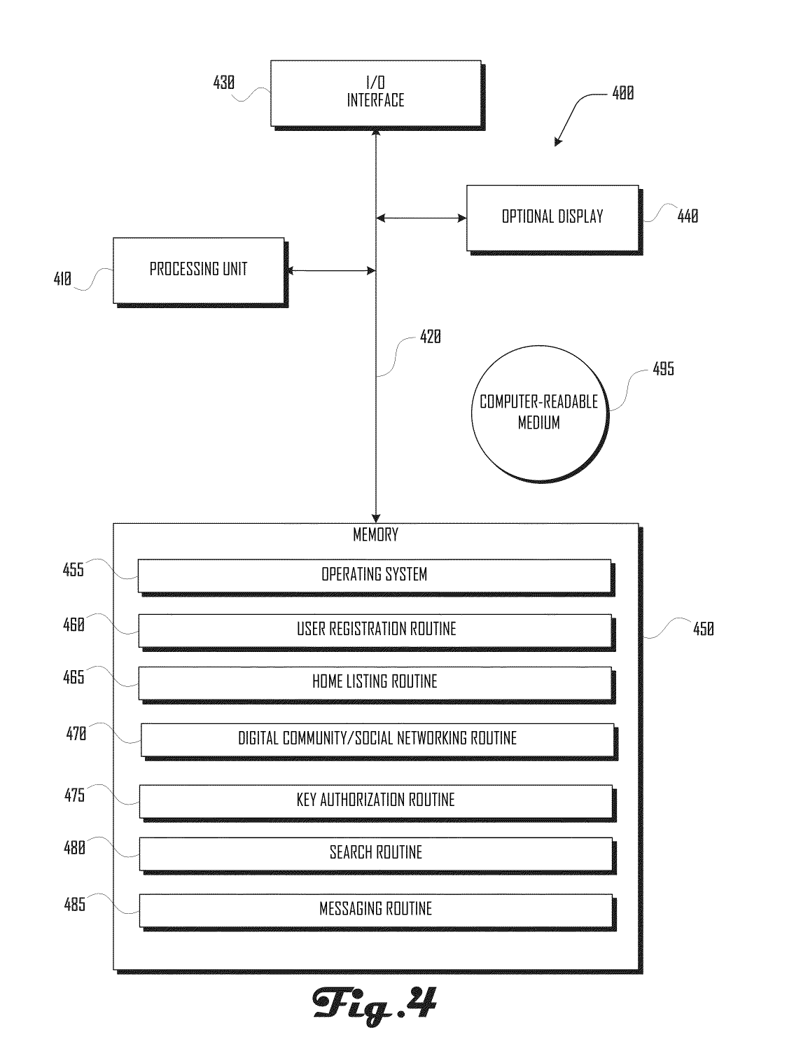

Referring now to FIG. 1, a suitable operating environment 100 for a property centric digital community is shown in accordance with at least one embodiment. The environment 100 includes a property server 400 coupling via communications network 120 to the various registered users. In one embodiment, the property server 400 may access an independent national database 130 populated by owners with home pages 140 for each of the owner's respective homes.

As shown, the environment 100 may include a digital community 105 of homes that are affiliated through a social sharing and social network of owner populated Home pages. The environment 100 may also include other digital communities (110, 205, 210, 215, 220, and 225) of homes that are affiliated through a variety of attributes including being listed for sale (110), remodeled (205), given a key to a home (210), the same estimated property value (215), the same build date (220), or at least one other owner-designated attribute (225). In one embodiment, the virtual neighborhood affiliations of home attributes may be based on any available data filter. In particular, data filters to distinguish groups of similar homes in at least one aspect. Examples of different owner-designated social attributes may include Addresses and/or locations (e.g., common addresses or not), same physical block, family members, social members or friends, religious affiliations, business affiliations, school affiliations. Other owner-designated attributes may include property specific attributes, such as lot size, directional exposure, foundation type, framing systems, siding materials (wood, stone, or stucco), window systems (e.g., by specific manufacturer), appliance types, main floor master configuration, contemporary style, Traditional style, European style, Porch front style, Courtyard style, Interior design, Staircase design, Stone fireplaces, LED lighting design, Kitchen Design, Bath Design, home amenities, and other physically distinctive traits that may be found in a home. Enabling organization into digital communities of similar homes allows owners to share information about contractors, service providers, warranties, photos, and maintenance tips, among other things. This makes the digital community useful for more than just home sales, as it may become a resource to the home owner. This may likely encourage the home owner to populate the home page of the home with more accurate information to take advantage of these social affiliations.

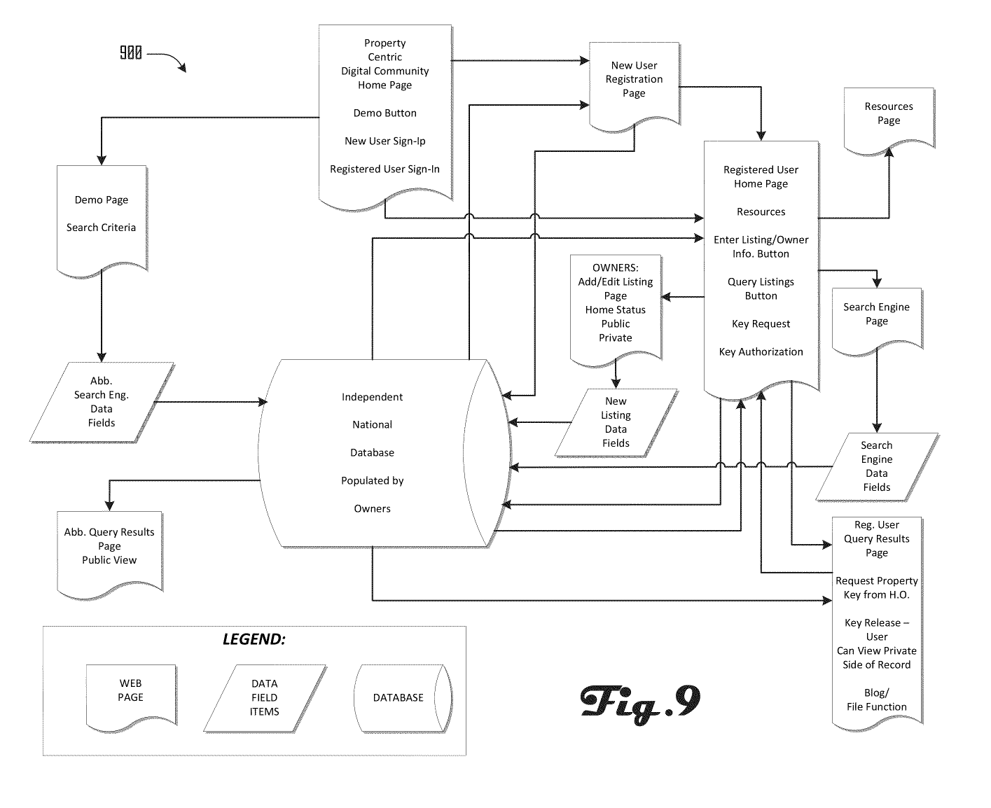

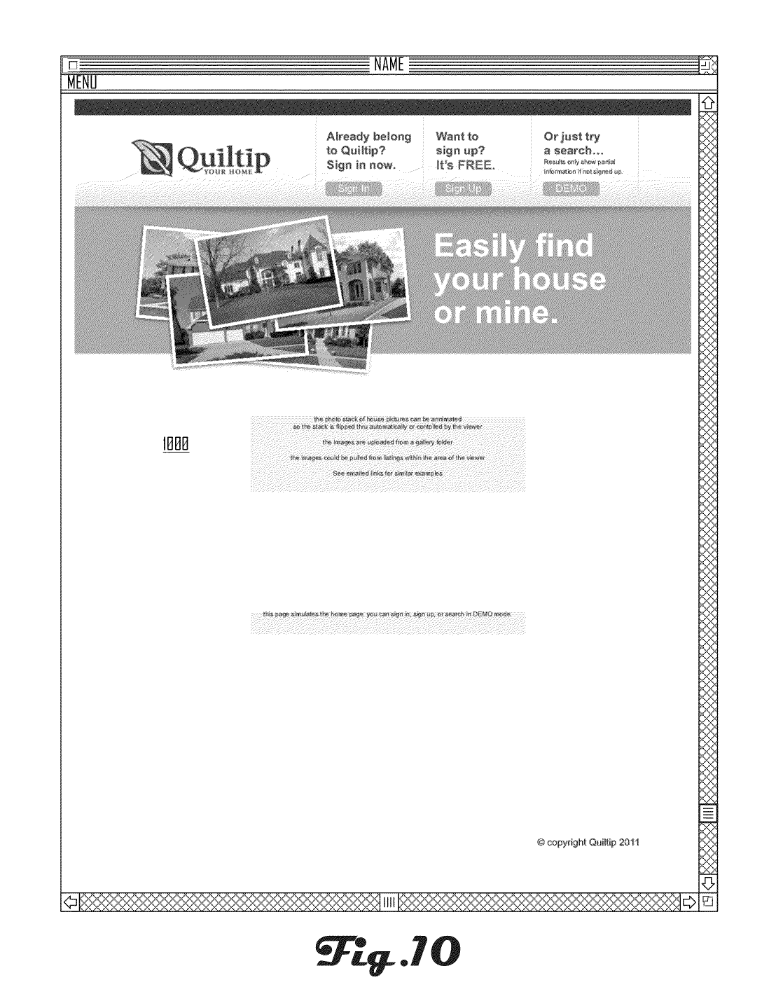

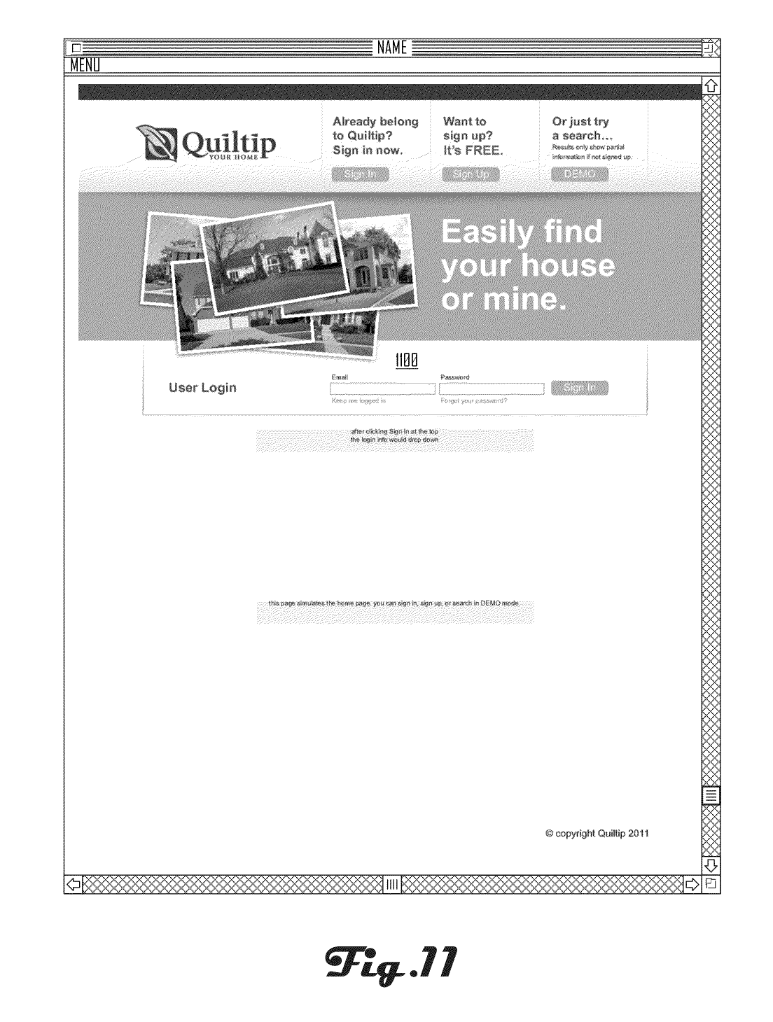

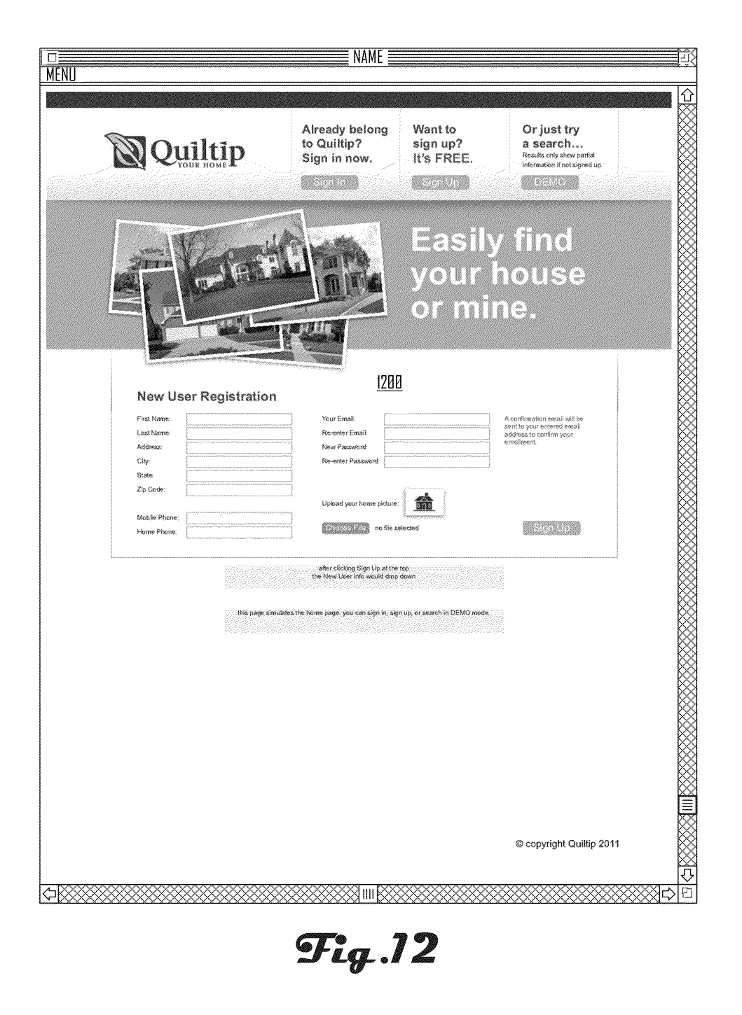

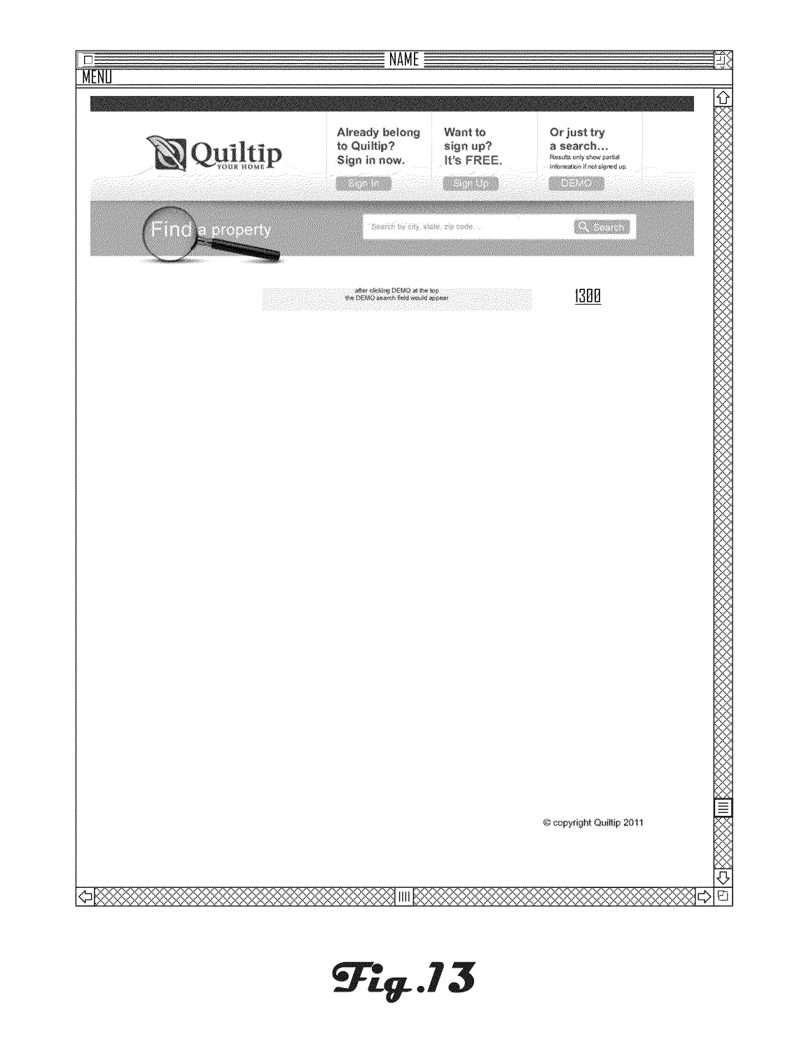

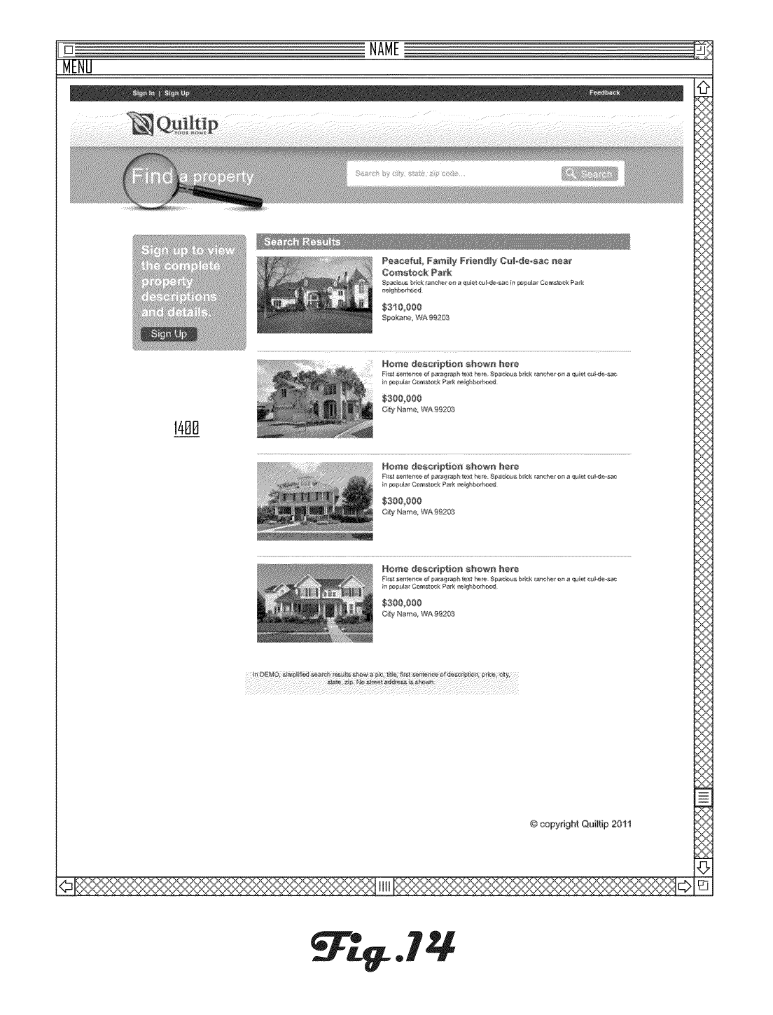

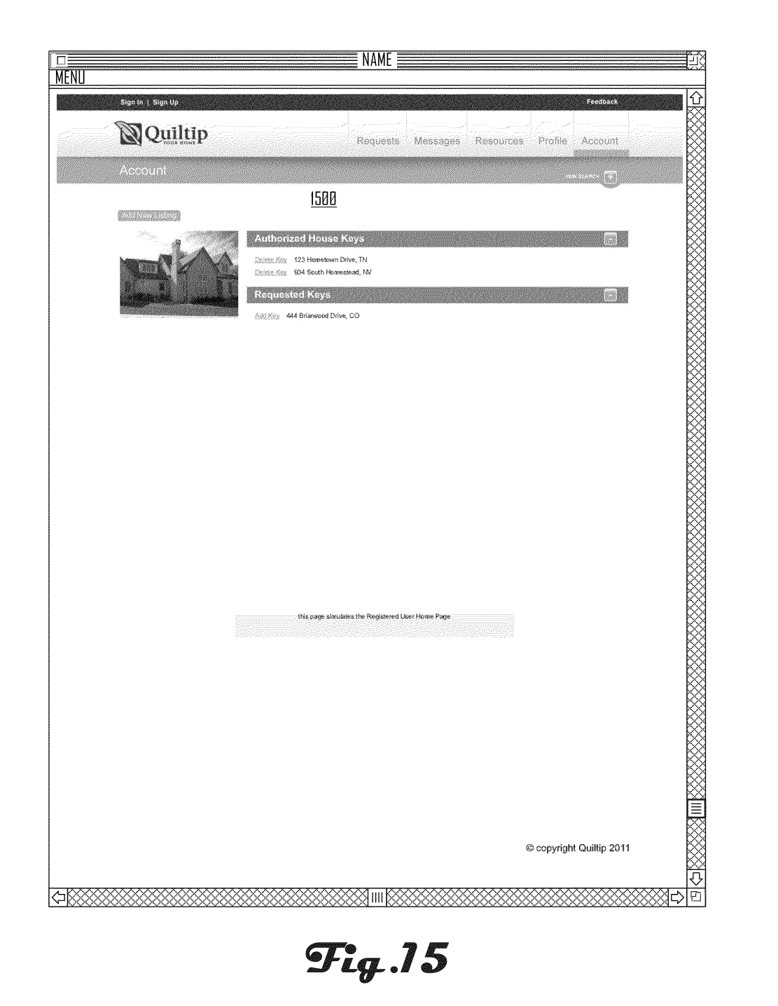

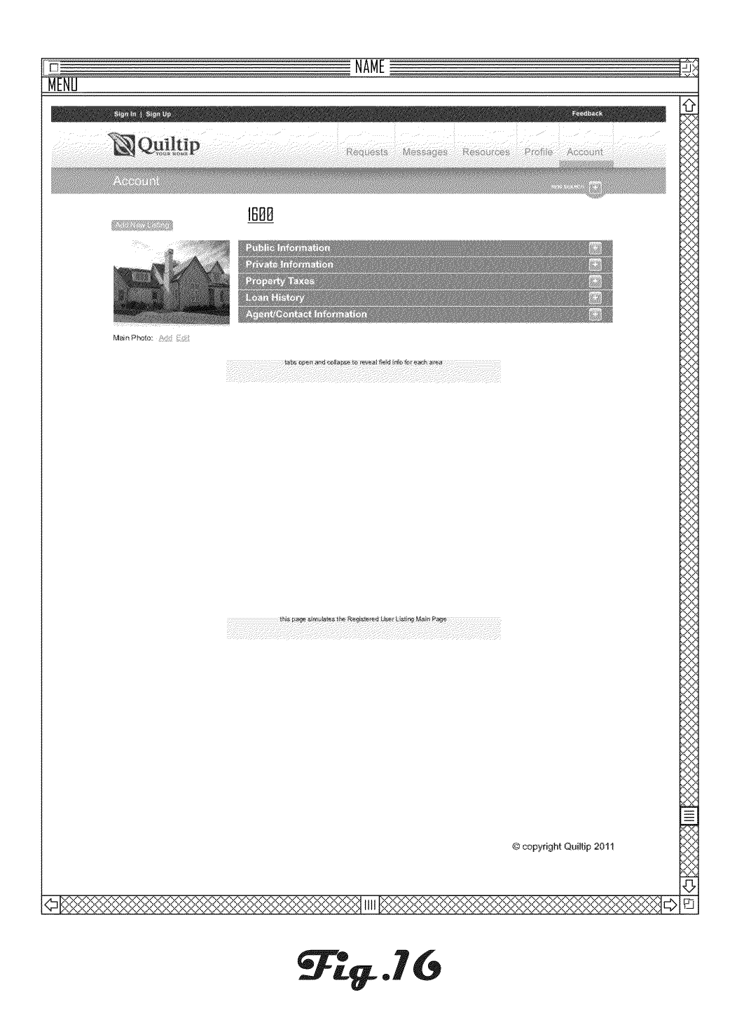

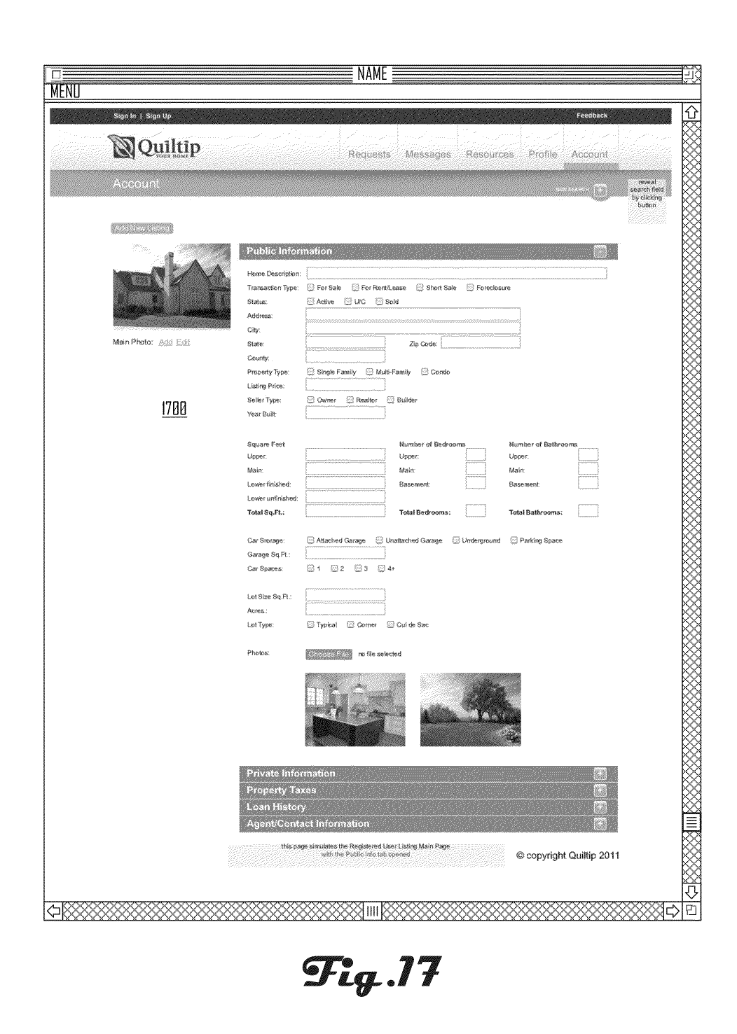

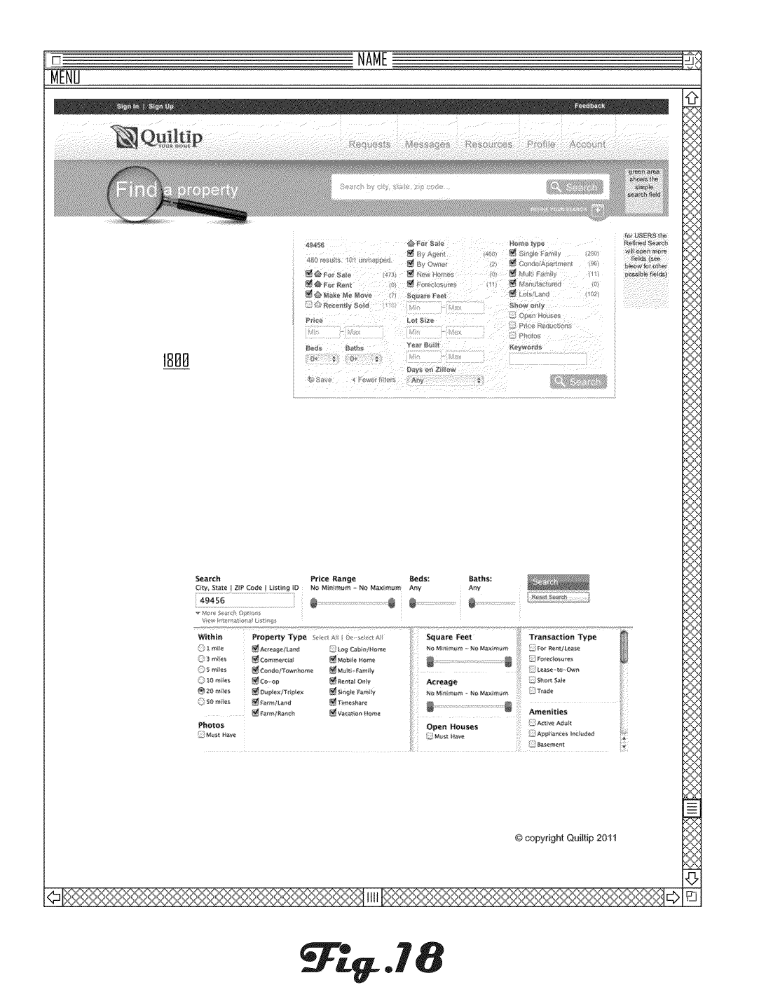

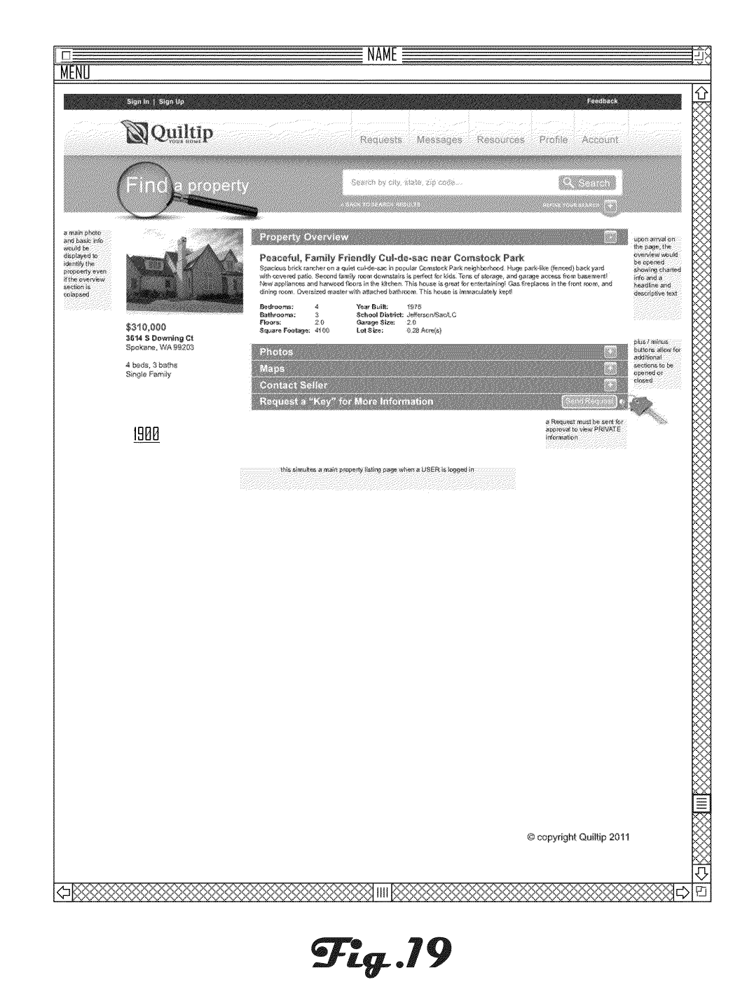

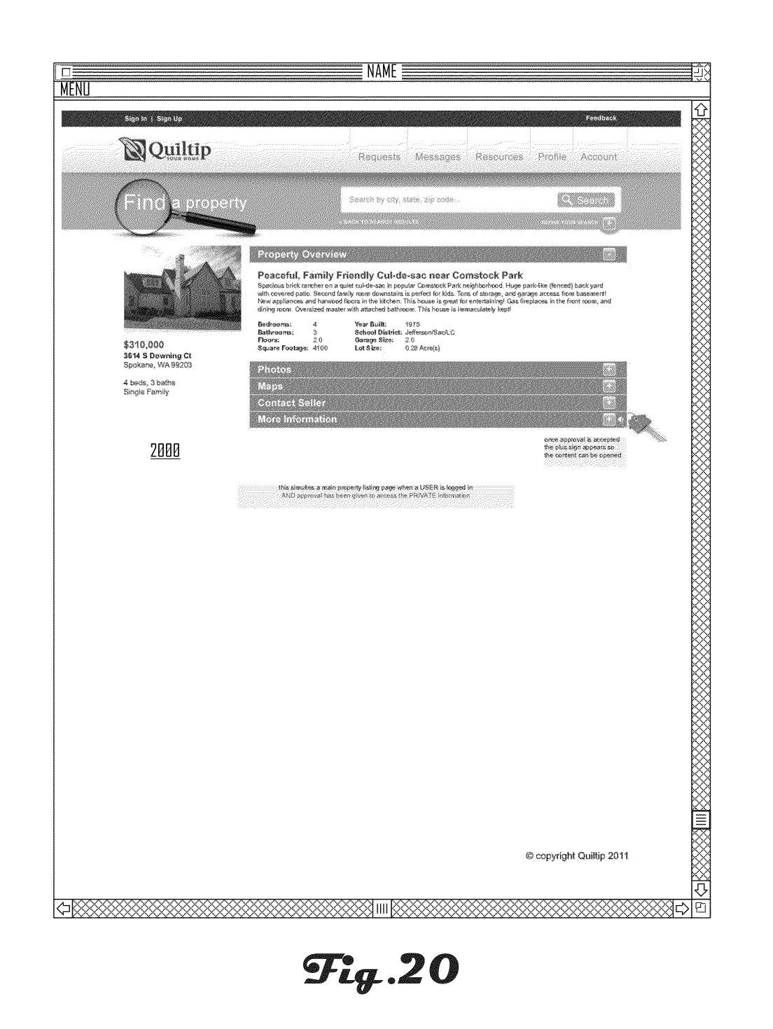

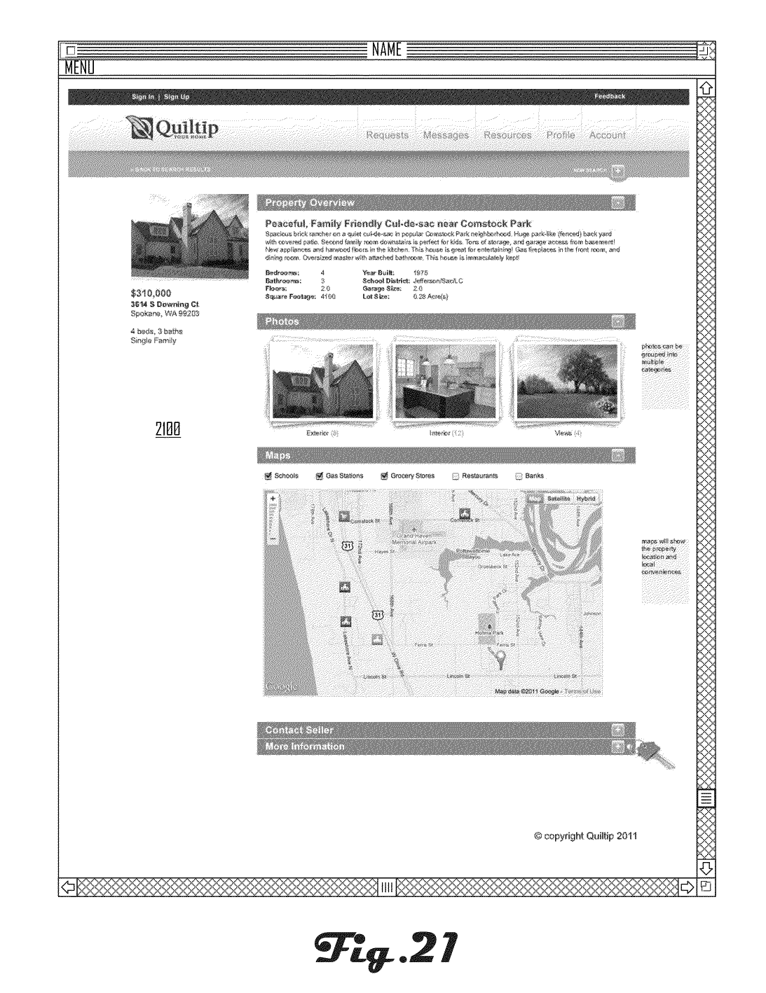

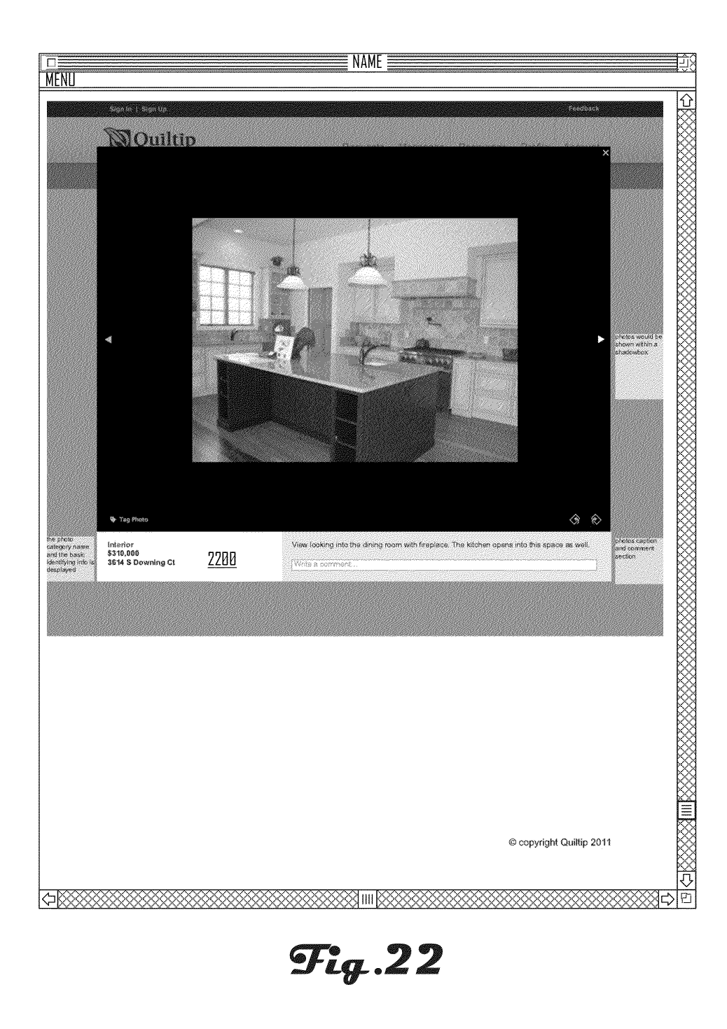

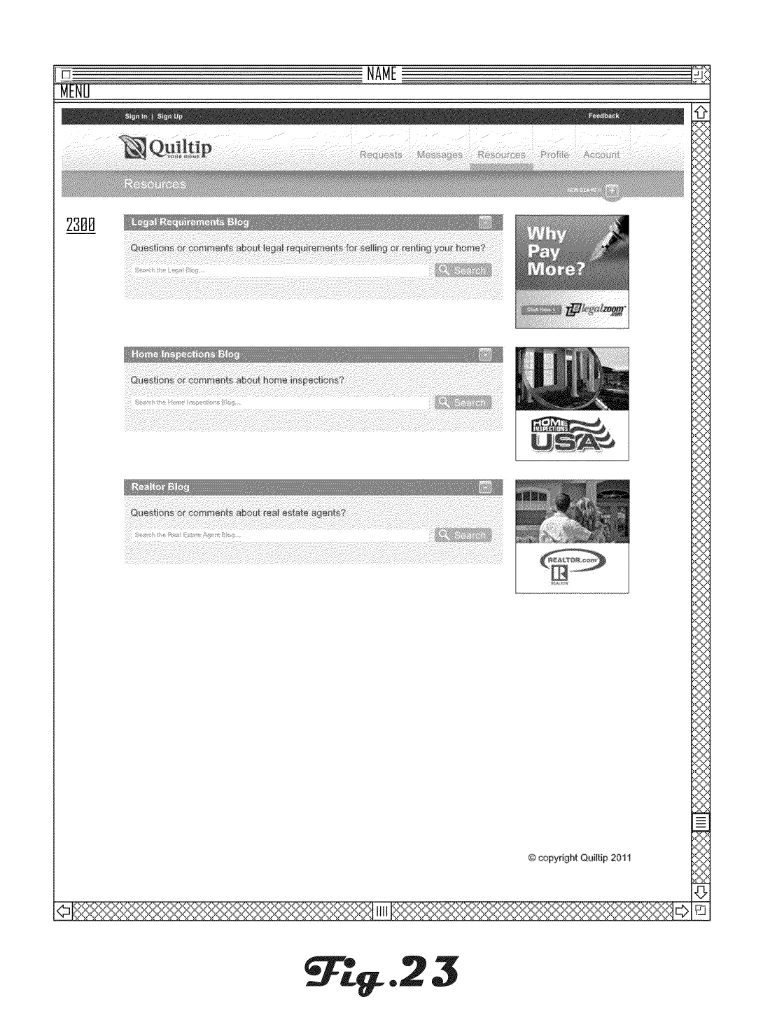

Technically, one embodiment of the property centric digital community as illustrated in FIGS. 1 and 9, utilizes a modular web site core that takes advantage of the latest client side and server side technologies including asynchronous javascript with xml, elements of HTML5 and ColdFusion 9. The system interfaces with a fully normalized, enterprise level database running on a dedicated Microsoft SQL Server and Microsfot .NET. In various embodiments, all available code languages may be used to generate applications and documents for use in the community including, among others, HTML, CSS, and JavaScript.

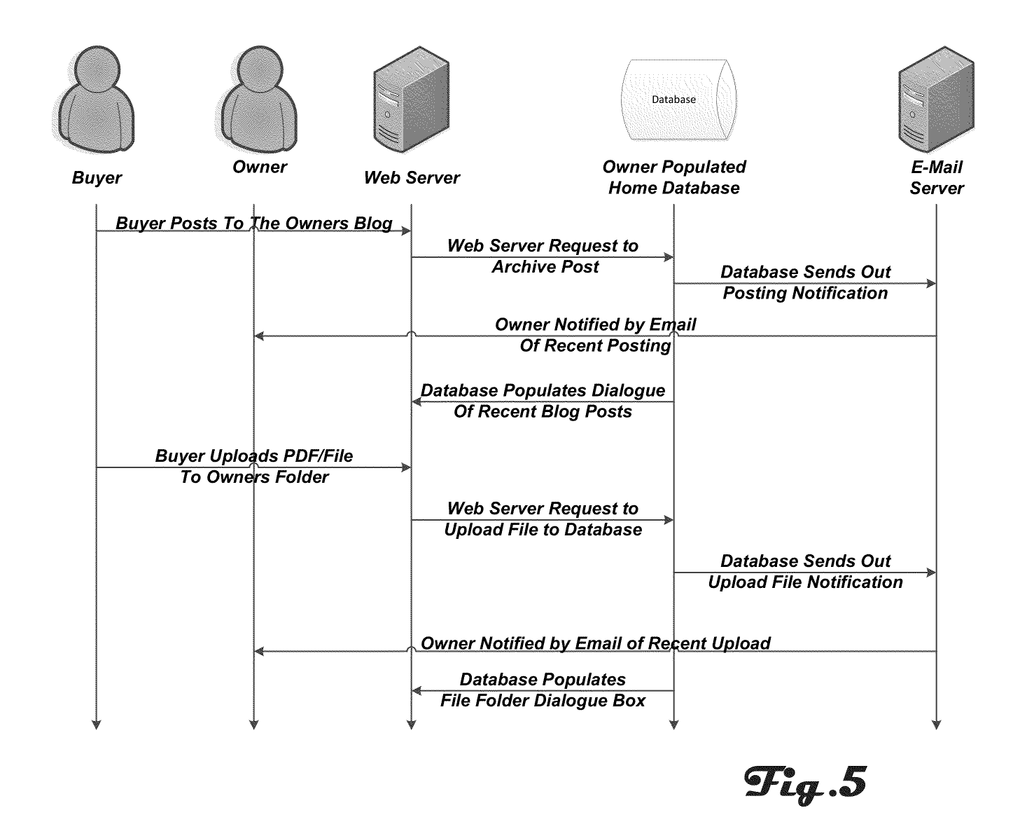

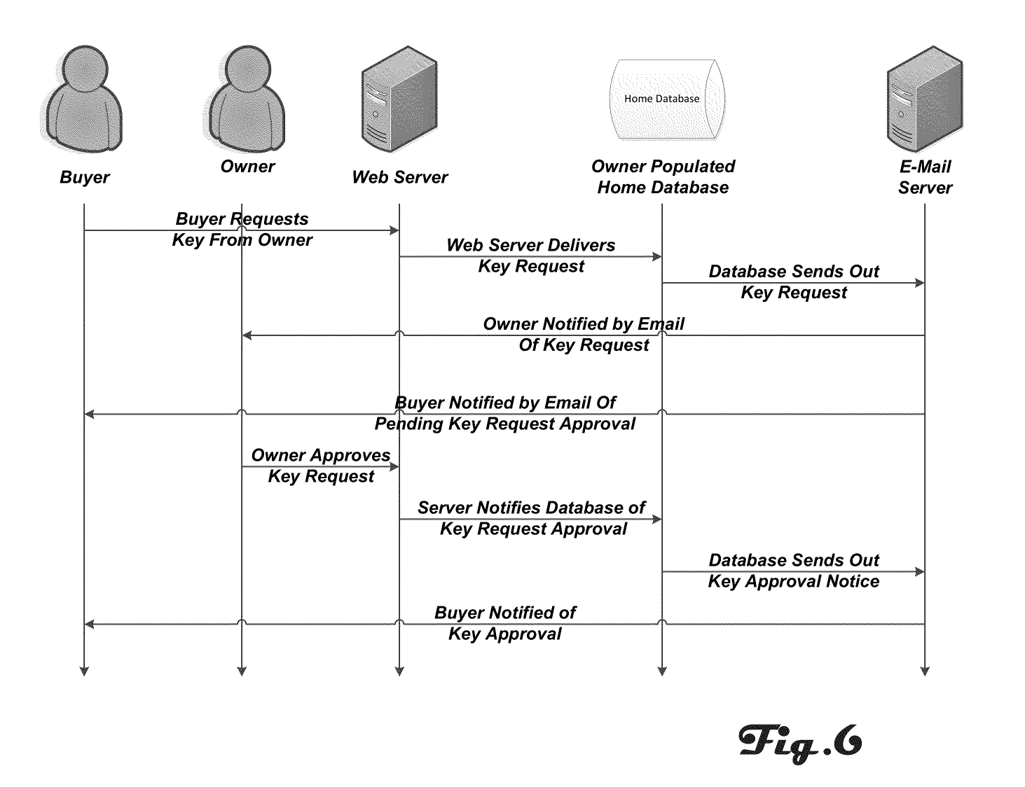

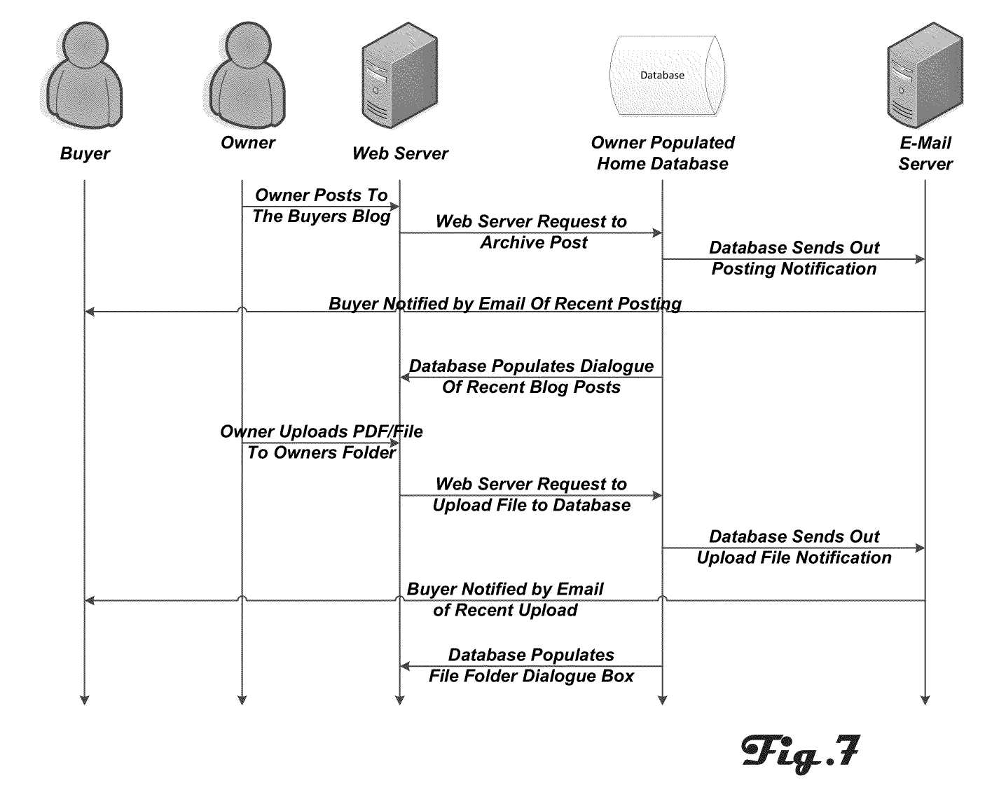

Logically, as illustrated in FIG. 9, one embodiment uses a cluster-server database configuration (e.g., see also FIGS. 5-8) that defends the privacy for all registered parties. Thus, in at least one embodiment, the potential buyers and sellers can remain relatively anonymous. In another embodiment, a registered user may conduct a more detailed search with more information being displayed in the results in accordance with the preferences of the searcher relative to the settings for the property listing.

Referring now to FIG. 6, the Key Program system is designed as a third layer of privacy controlled by the Owner or his agent and functions as follows:

When a user requests a Key from the Owner, an email will be sent to the Owner showing a Key has been requested. When a Key is authorized by the Owner, an email will be sent to the requesting party telling them that a key was granted and the private portion of the property database can now be accessed. Once a Key has been granted, a dialog registry (Owner's blog) and file registry (Owner's folder) may begin between the Owner and searching parties. This new “dialog” or social networking portion of the system may be designed as follows: Once granted a Key, the searching party may have a box where they could communicate (ask and answer questions) with the Owner. The box may show them all of the questions asked and all of the answers they received, by date. Text will be colored so it is obvious which entries were from the searching party and which entries were from the Owner. The searching party may be notified by email every time the Owner makes an entry (replies to a question). The Key box for the Owner may show when they granted a key to a searching party, with all of the questions asked by the searching party, and their replies. This may let them keep in contact with the various individuals interested in each of the properties the Owner has listed. In one embodiment, text may be colored so it is obvious which entries were from the searching party and which entries were from the listing party. In various embodiments, the owner may be notified by email each time a searching party makes an entry (asks a question or replies to a question). Because this box may grow to contain large amounts of correspondence, there will be buttons that may allow the user to collapse various sections. This dialog section will also be used to exchange documents (pdf's) for signatures, etc.

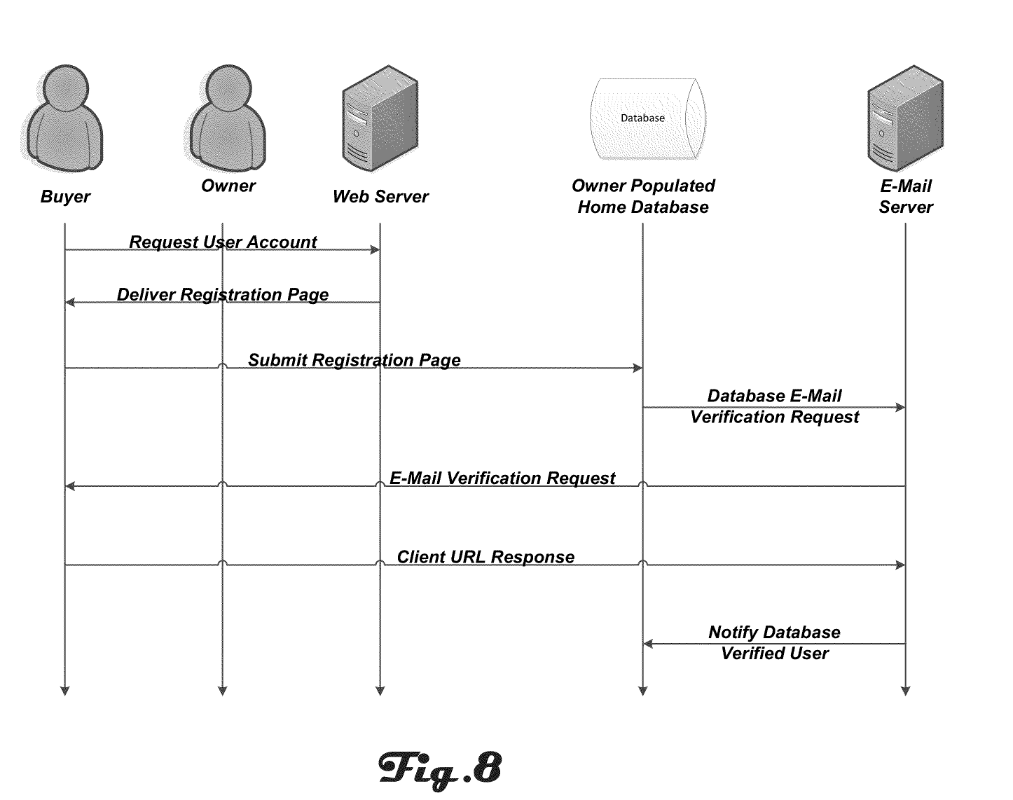

Referring now to FIG. 8, among other activities, the database 130 will keep track of the last time a user changes email addresses and the last time that a email address is successfully verified. When a user registers or changes his email address, the system will send him an email with an encoded URL asking him to click on the link to complete the registration. Upon system confirmation that the user navigated to that URL, it will thank him, record that his email was successfully validated and let him into the system. If a registered user attempts to log in and has not successfully validated his email, he will be notified that he may complete the process before logging in.

As shown in FIG. 9, one embodiment has a separate system to keep track of mail delivery. If the Owner sends email (via the dialog portion of the system) to a searching party, and that mail could not be delivered, the Owner may be notified. Likewise, if the searching party sends email (via the dialog portion of the system) to a Owner, and that mail could not be delivered, the searching party may be notified.

In one embodiment, the digital community site will provide immediate transparency, will not export any information/data, and transitional links will be kept to a minimum. The input of information will follow a simple logical format that will be presented in a public format for sale and a private format for social networking with a true home page. The communication format that will be implemented will allow each homeowner the ability to be contacted directly, anonymously, through a Realtor®, or an identified agent (lawyer). The private social networking capability will be by private invitation to registered users only. In one embodiment, privacy of information will be a priority concern, and any status change will be updated and confirmed by the homeowners regularly via directed email notifications sent by the system. In one embodiment, the new property centric digital community program provides a free database that works For-Sale-By-Everyone, with the “Owner” in control both publicly and privately.

Although specific embodiments have been illustrated and described herein, a variety of alternate and/or equivalent implementations may be substituted for the specific embodiments shown and described without departing from the scope of the present disclosure. This application is intended to cover any adaptations or variations of the embodiments discussed herein.

1. A method in a computer system that provides online access to select homes within a property centric digital community, comprising:
programmatically analyzing select home attributes of each of the homes in the property centric digital community to identify at least one attribute that is commonly shared by at least two homes in the property centric digital community;
in response to identifying the at least one attribute, electronically exposing a potential association between the homes sharing the common attribute within the property centric digital community; and
establishing virtual neighborhoods of homes within the property centric digital community based on sharing at least one desired common attribute.

2. The method of claim 1, wherein each home may provide at least three levels of access to home attributes consisting of public, private, and key access.

3. The method of claim 1, wherein each home may conduct social networking activities approved within a designated virtual neighborhood.

4. The method of claim 3, wherein the social networking activities may include messaging and/or blog posts.

5. The method of claim 1, wherein each home profile may include a QR code to direct visitors to additional information regarding the home.

6. The method of claim 5, wherein each home may include a physical QR code having a link to a home profile within the property centric digital community.

7. The method of claim 1, wherein each home profile may include a resource page of links relevant to a particular home based in part on home attributes.

8. The method of claim 1, wherein each home profile designates an owner.

9. The method of claim 8, wherein the designated owner is notified of any changes to the home profile.

10. The method of claim 9, wherein proposed modifications to the home profile are first approved by the designated owner.
